(19) United States
(12) Patent Application Publication
(10) Pub. No.: US 2025/0039650 A1
(43) Pub. Date: Jan. 30, 2025

(54) Method for Registering a User to a Vehicle, Computer-Readable Medium, System, and Vehicle

(71) Applicant: Bayerische Motoren Werke Aktiengesellschaft, Muenchen (DE)

(72) Inventor: Markus Walter, Poecking (DE)

(21) Appl. No.: 18/834,962

(22) PCT Filed: Nov. 29, 2022
(86) PCT No.: PCT/EP2022/083741

§ 371 Date: Jul. 31, 2024

(30) Foreign Application Priority Data
Feb. 16, 2022 (DE) 10 2022 103 570.0

(51) Int. Cl. H04W 4/40; H04W 4/029; H04W 12/06; H04W 12/084

(52) U.S. Cl. CPC H04W 4/40; H04W 4/029; H04W 12/06; H04W 12/084

(57) ABSTRACT

A method for logging a user into a vehicle includes identifying a mobile terminal of the user, wherein the mobile terminal of the user is identified using a first wireless communication protocol. The method also includes determining a seating location of the user in the vehicle. The seating location of the user in the vehicle is determined using a second wireless communication protocol. The method further includes logging the user into the determined seating location in the vehicle using the vehicle.

The present application is the U.S. national phase of PCT Application PCT/EP2022/083741 filed on Nov. 29, 2022, which claims priority of German patent application no. 10 2022 103 570.0 filed on Feb. 16, 2022, the entire contents of which are incorporated herein by reference.

### TECHNICAL FIELD

The disclosure relates to logging a user into a vehicle, and methods, systems, vehicles and computer-readable media therefor.

### BACKGROUND

In the latest vehicles, a user of the vehicle can enter his/her login data via a display in the vehicle, in order to log into the vehicle. It is also known to enable a user to log into a vehicle by scanning a QR code displayed on a vehicle display using a camera of a mobile terminal. In the known prior art, an interaction with a vehicle display is always necessary for the user to log into the vehicle.

There is a need, however, for efficiently simplifying a log-in of a user to a vehicle. In particular, there is a need to enable all users, in particular all occupants, of a vehicle to log in more easily and more precisely.

### SUMMARY

The above-discussed needs, as well as others, are addressed by at least some embodiments described herein, at least some of which automate a log-in of a user to a vehicle. Advantageous embodiments and developments will become apparent from the claims.

A first aspect is a method for logging a user into a vehicle. The method can be a computer-implemented method and/or a control device-implemented method. The user can be an occupant, a driver, a front-seat passenger, and/or a rear-seat passenger of the vehicle. The method can carry out the log-in of the user without the user interacting with a display device in the vehicle. In other words, the method can be carried out for logging a user into the vehicle regardless of an interaction of the user with a display device in the vehicle. The user can log into the vehicle using a mobile terminal that the user has brought along into the vehicle. The mobile terminal can be a smartphone, a smartwatch, smartglasses, a tablet, and/or another mobile terminal belonging to the user. The vehicle can be a motor vehicle.

The method identifies a mobile terminal of the user, the mobile terminal of the user being identified using a first wireless communication protocol. In addition, the method determines a seating location of the user in the vehicle, the seating location of the user in the vehicle being determined using a second wireless communication protocol. The first wireless communication protocol and the second wireless communication protocol are preferably different wireless communication protocols. Finally, the method can log the user into the determined seating location in the vehicle by means of the vehicle.

Advantageously, a user can log into the vehicle and, in particular, into a specific seating location in the vehicle without interacting with a display device in the vehicle, in particular with a display-control unit. The mobile terminal and the seating location in the vehicle, at which the mobile terminal and the user are located, can be determined in an automated manner using two wireless communication protocols. Therefore, the method can efficiently simplify the log-in of a user to the vehicle. A user can efficiently log into a seating location in the vehicle using the mobile terminal even if this seating location does not have a display device or a display-control unit.

According to an advantageous embodiment, logging the user into a determined seating location in the vehicle by means of the vehicle can include providing a message to log the user into the determined seating location in the vehicle from the vehicle to the mobile terminal of the user, receiving a confirmation message to log the user into the determined seating location from the user by means of the mobile terminal, transmitting the received confirmation message from the mobile terminal to the vehicle, and, once the confirmation message has been received, logging the user into the determined seating location in the vehicle by means of the vehicle. In this way, the security associated with logging the user into a seating location in the vehicle can be increased. The user must initiate the log-in to the vehicle by means of the confirmation message in order for the user to be logged into the seating location in the vehicle.

According to some embodiments, the message to log the user into the determined seating location can include one single button on a graphical user interface of the mobile terminal, with which the user can log into the determined seating location in the vehicle. In this way, the log-in of the user can be efficiently simplified.

In some cases, the confirmation message can include one single interaction of the user with the one single button of the graphical user interface of the mobile terminal. In this way, the log-in of the user can be efficiently simplified.

According to one or more embodiments, the method can also include configuring the determined seating location in the vehicle depending on a user-specific profile once the user has logged into the determined seating location. In this way, the user can flexibly define the seating location to which the user would like to log in.

The first wireless communication protocol can be Bluetooth LOW Energy, and/or the second wireless communication protocol can be ultra-wideband. In this way, the mobile terminal can be efficiently identified and localized.

According to some embodiments, logging the user into the determined seating location in the vehicle an authentication and authorization of the user can be carried out by means of a standardized authentication and/or authorization protocol, and/or the user can be authenticated and/or authorized on the basis of an OAuth 2.0 protocol, and/or a user code and/or a verification URI of the OAuth 2.0 protocol can be transmitted from the vehicle to the mobile terminal of the user by means of the Bluetooth Low Energy protocol. The authentication of the user can be carried out, for example, by means of OpenID Connect. OpenID Connect can authenticate an identity of the user on the basis of the OAuth 2.0 protocol and thus authenticate the user. The authorization of the user can be carried out by means of OAuth 2.0. In this way, the user of the vehicle can be authenticated and/or authorized in an automated manner. The certainty of the log-in of the user can therefore be efficiently increased.

A further aspect is characterized by a computer-readable medium for logging a user into a vehicle, and the computer-readable medium has instructions which, when run on a computer and/or a control unit, carry out the above-described method.

A further aspect is characterized by a system for logging a user into a vehicle, wherein the system is designed to carry out the above-described method.

Still a further aspect is characterized by a vehicle having the above-described system for logging a user into a vehicle.

Further features may be seen from the claims, the figures, and the description of the figures. All features and combinations of features mentioned above in the description, as well as the features and combinations of features mentioned in the following in the description of the figures and/or shown individually in the figures, are usable not only in the particular combination indicated, but also in other combinations or alone.

An exemplary embodiment is described in the following with reference to the attached drawings. Further details, preferred embodiments and developments will become readily apparent to those of ordinary skill in the art.

### BRIEF DESCRIPTION OF THE DRAWINGS

FIG. 1 schematically shows an exemplary method for logging a user into a vehicle,

FIG. 2 schematically shows an exemplary method for identifying a mobile terminal of the user,

FIG. 3 schematically shows an exemplary method for determining a seating location of the user in the vehicle, and

FIG. 4 schematically shows an exemplary method for logging the user into the determined seating location in the vehicle.

### DETAILED DESCRIPTION

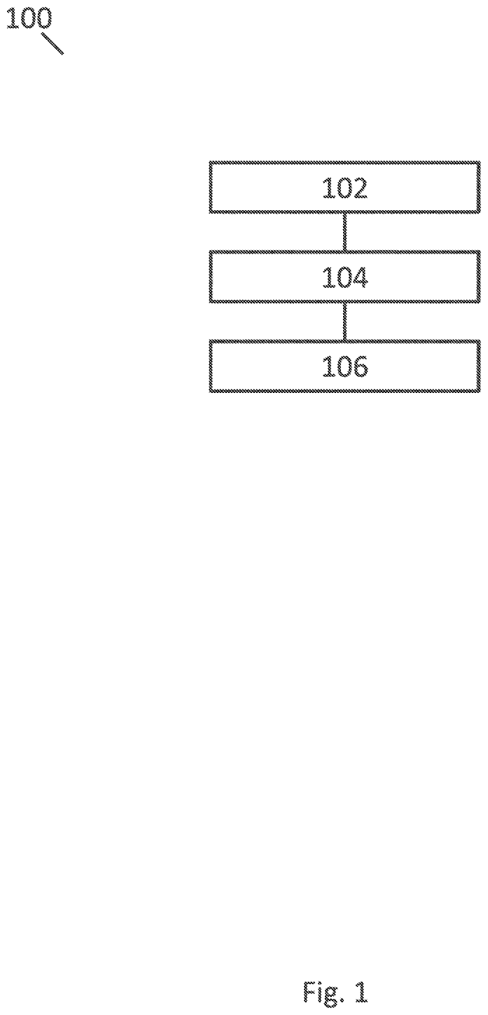

In detail, FIG. 1 shows an exemplary method 100 for logging a user into a vehicle. A user can step into a vehicle with a mobile terminal and take a seat inside the vehicle. At the seating location, the user can log in by means of the mobile terminal and thus use and/or control one or more functions of the seating location in the vehicle and/or one or more functions of the vehicle. For example, the use and/or the control of a function can include an automated personalization of the function according to user-specific requirements. Functions of the vehicle can be, for example, a sitting position, a climate control setting, a light color, a configuration of a digital media service of the vehicle, and/or a navigation function. The user can log into the seating location by means of one single user input from the user. For example, the user input can be a gesture, a touch input, and/or an input using a mechanical operating element of the mobile terminal.

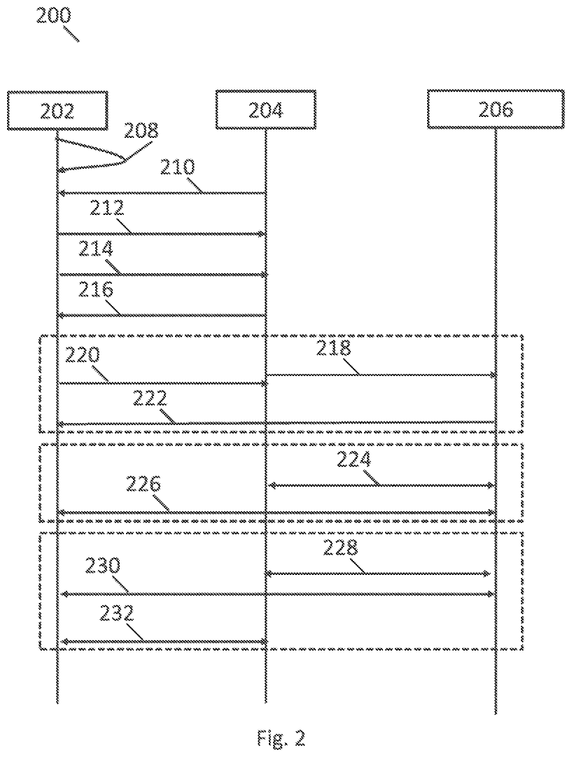

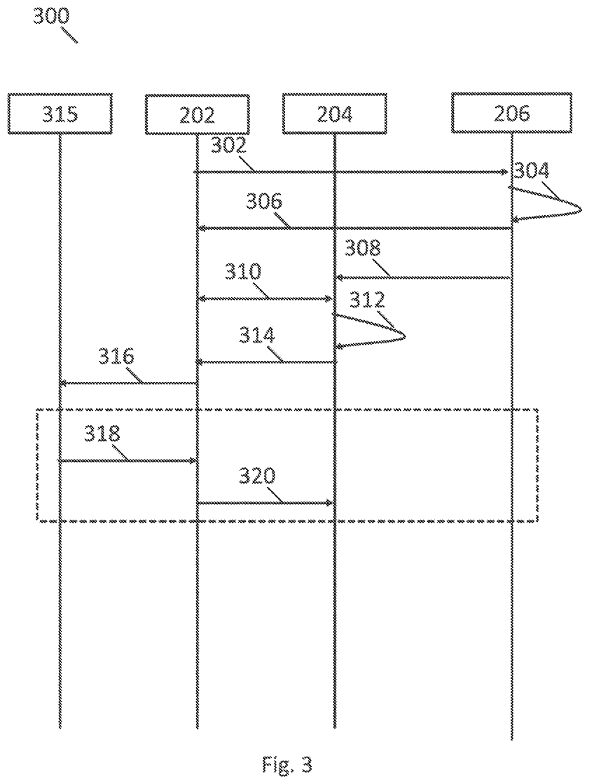

The method 100 can identify 102 a mobile terminal of the user. FIG. 2 shows an exemplary method for identifying 102 a mobile terminal of the user. In addition, the method 100 can determine 104 a seating location of the user in the vehicle. FIG. 3 shows an exemplary method for determining 104 a seating location of the user in the vehicle. The identification 102 of the mobile terminal of the user and the determination 104 of the seating location of the user can be carried out sequentially or in parallel. Preferably, the identification 102 of the mobile terminal is carried out in parallel to the determination 104 of the seating location. Alternatively, the mobile terminal may have already been identified outside the vehicle. As another alternative, the mobile terminal is first identified when the user takes a seat in the vehicle.

The method 100 can provide a message to log the user into the determined seating location in the vehicle from the vehicle to the mobile terminal of the user. For example, the message to log in the user can be provided in an app or a widget on the mobile terminal. The message can include a button or another clickable feature to log the user into the seating location in the vehicle. A confirmation message to log the user into the determined seating location can be received from the user by the mobile terminal. For example, the confirmation message can include pressing the button or another interaction with another clickable feature that was displayed to the user on the mobile terminal. The received confirmation message can be transmitted from the mobile terminal to the vehicle.

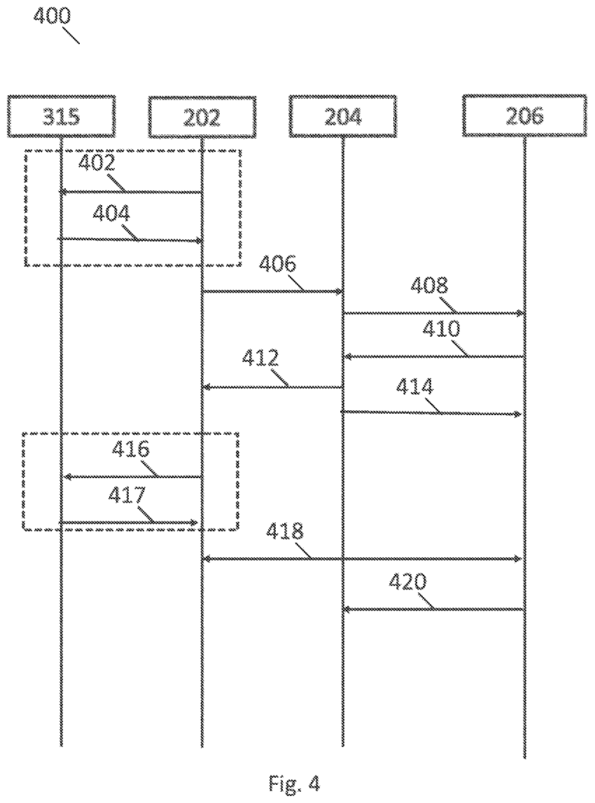

The method 100 can log in 106 the user to the determined seating location in the vehicle by means of the vehicle. FIG. 4 shows an exemplary method for logging the user into the determined seating location. For example, once the confirmation message has been received, the user can be logged into the determined seating location in the vehicle by means of the vehicle. Once the user has logged in 106, the vehicle can provide functions and/or services to the logged-in user, in a personalized manner, in particular at the seating location of the user in the vehicle.

The method 100 can store the logged-in user in the vehicle. If the mobile terminal of the stored user is identified by the vehicle, the user can be logged into the seating location in an automated manner without the user interacting with the mobile terminal. Alternatively, the method 100 can log off the user in an automated manner when the user leaves the seating location in the vehicle and steps out of the vehicle.

In detail, FIG. 2 shows an exemplary method 200 for identifying 102 a mobile terminal 202 of the user. The mobile terminal 202 can run a mobile application, which is also referred to as an app in the following, which carries out the identification of the mobile terminal in communication with a vehicle 204 and/or a backend server 206. The mobile application can be run in the background on the mobile terminal. Preferably, the mobile application is an application from the vehicle manufacturer, which enables use and/or control of vehicle functions and vehicle-specific backend functions. The communication between the mobile terminal 202 and the vehicle 204 can take place via a first wireless communication interface, preferably Bluetooth and/or Bluetooth LOW Energy. The communication between the mobile terminal 202 and the backend server 206, and between the vehicle 204 and the backend server 206, can take place, for example, via a mobile communication interface.

The mobile terminal 202 can scan 208 a predefined log-in service. The scanning 208 can be carried out continuously by the mobile terminal 202. The vehicle 204 can offer 210 the predefined log-in service. The mobile terminal 202 can identify 212 the offered log-in service and connect 214 to the vehicle. The vehicle can offer 216 parameters to the mobile terminal. The mobile terminal can use the offered parameters to retrieve data from the vehicle and transmit data from the mobile terminal to the vehicle.

For example, the vehicle can offer the following parameters to the mobile terminal:

| Parameter | Description |
|---|---|
| Identifier of the log-in | Unique identifier that |
| service | identifies the log-in |
| | service; the vehicle offers |
| | the log-in service with the |
| | unique identifier; the |
| | mobile terminal scans the |
| | log-in service with the |
| | unique identifier; |
| Public vehicle identifier | The public vehicle |
| | identifier can be used for |
| | secure device validation of |
| | the offered log-in service; |
| | for example, the public |
| | vehicle identifier can be a |
| | random UUID. For example, |
| | the public vehicle |
| | identifier can be changed |
| | every time the log-in |
| | service is offered. |
| User code | Transmission of a user code |
| | from the vehicle to the |
| | mobile terminal; the user |
| | code can be used to |
| | authenticate the user. |
| Uniform Resource Identifier | Transmission of a URI from |
| (URI) | the vehicle to the mobile |
| | terminal; the URI can be |
| | used to authenticate the |
| | user. |
| Propose a sitting position | Provide a proposal for a |
| | sitting position from the |
| | vehicle to the mobile |
| | terminal |
| Select a sitting position | Transmission of a selected |
| | sitting position from the |
| | mobile terminal to the |
| | vehicle |
| Confirm the log-in request | Parameters for initiating a |
| | log-in process of the user |
| | to the vehicle by means of |
| | the mobile terminal |

Table 1: Exemplary parameters that are offered from the vehicle to the mobile terminal in order to transmit data from the mobile terminal to the vehicle, from the vehicle to the mobile terminal.

The steps 218 through 220 can be optionally carried out in order to increase the certainty of identification 102 of the mobile terminal. In step 218, the vehicle 204 can generate a public vehicle identifier and transmit this to the backend server 206. The public vehicle identifier can be generated by the vehicle if the vehicle offers the log-in service to a mobile terminal. In addition, the vehicle can generate a new public vehicle identifier when the log-in service is offered to a mobile terminal again. As a result, tracking of offered log-in services can be prevented and the privacy of the method 200 can be improved. In addition, the situation is prevented in which the mobile terminal communicates with unknown devices, for example, unknown vehicles, which offer a log-in service that does not correspond to the log-in service of the vehicle in which the user has taken a seat.

In step 220, the mobile terminal 202 can retrieve the public vehicle identifier from the vehicle. Thereafter, the mobile terminal can have the public vehicle identifier checked 222 by the backend server 206. The backend server 206 can transmit a result of the check to the mobile terminal. If the result of the check is that the public vehicle identifier is valid, the mobile terminal can establish a preferably secure link to the vehicle and, in particular, to the log-in service of the vehicle. If the result of the check is that the public vehicle identifier is not valid, the mobile terminal can abort the method with the log-in service and scan for another log-in service.

In addition, the steps 218 through 220 can be used to retrieve vehicle-specific information as additional log-in information. For example, a vehicle type, a number of seats, a color of the vehicle, a color of the vehicle seats, and/or further vehicle-interior-specific details can be retrieved.

The steps 224 and 226 are optional and form a first possibility to establish a secure communication link between the mobile terminal and the vehicle. With the steps 224 and 226, a secure, indirect communication link between the mobile terminal and the vehicle can be established. For this purpose, a secure communication link can be established 224 between the mobile terminal 202 and the backend server 206 and a secure communication link can be expanded 226 between the backend server and the vehicle. The communication between the mobile terminal and the vehicle can only take place indirectly via the backend server. For this purpose, for example, an existing, secure communication link between an app of the mobile terminal and the backend server can be used. The secure, indirect communication link has the advantage that attacks on the wireless interface between the mobile terminal and the vehicle can be prevented. For example, local BLE attacks can be prevented due to the secure, indirect communication link.

The steps 228 and 230 are optional and form a second possibility to establish a link between the mobile terminal and the vehicle. Steps 228 and 230 enable a secure, direct communication link between the mobile terminal and the vehicle to be established. In step 228, the exchanges security data with the mobile terminal via the backend server, such as, for example, cryptographic keys and/or security certificates, in order to achieve a secure, direct communication channel. In step 230, the mobile terminal exchanges security data with the vehicle via the backend server, such as, for example, cryptographic keys and/or security certificates, in order to achieve a secure, direct communication channel. For example, by means of the security data exchanged via the backend server, a secure BLE communication channel can be established between the mobile terminal and the vehicle.

In detail, FIG. 3 shows an exemplary method 300 for determining 104 a seating location of the user in the vehicle. The exemplary method 300 shown in FIG. 3 can take place a seating location of the user by using an ultra-wideband, UWB, based identification of the mobile terminal. The mobile terminal 202 can retrieve 302 a UWB token from the backend server 206. The backend server 206 can generate 304 the UWB token and transmit 306 this to the mobile terminal 202. In addition, the backend server 206 can transmit 308 the generated UWB token to the vehicle 204. For example, the backend server can transmit 308 the UWB token to the vehicle 204 by means of a push message. The vehicle 204 can determine 310 a position of the mobile terminal by means of UWB. For example, the vehicle can continuously determine the position of the mobile terminal by means of UWB in order to be able to detect a change in the position of the mobile terminal. In addition, the vehicle 204 can generate 312 a proposal for a sitting position on the basis of the position of the mobile terminal. The generated proposal for the sitting position can be transmitted 314 from the vehicle to the mobile terminal. For example, the generated proposal for the sitting position of the user can be transmitted 314 from the vehicle to the mobile terminal with the parameter “propose a sitting position”. The mobile terminal 202 can provide 316 the proposed sitting position to a user 315. For example, the proposed sitting position can be displayed to the user in an app on the mobile terminal. Optionally, the user can manually change 318 the proposed sitting position. The changed sitting position can be transmitted 320 from the mobile terminal 202 to the vehicle. For example, the changed sitting position can be transmitted 320 from the mobile terminal 202 to the vehicle with the parameter “select a sitting position”.

In order to generate a proposal for a sitting position by means of the UWB protocol, various input parameters can be used:
UWB device localization
seating location occupancy
door-opening states
belt states, and/or
camera-based person recognition in the interior of the vehicle

As output parameters, in addition to the proposal for the sitting position, an accuracy of the estimated proposal can also be provided. Statistical state estimation algorithms can be used as an algorithm for determining the sitting position. For example, an extended Kalman filter can be used, in which a separate state estimator is used for each seating location in the vehicle and the state estimator of a seating location having the greatest accuracy is proposed as the sitting position of the user. Alternatively, a particle filter can be used, which forms clusters of seating locations for each seating location in the vehicle. The cluster of seating locations, in which most of the positions of the mobile terminal are located, is proposed as the sitting position of the user. Alternatively, in order to generate the proposal for the sitting position, a predefined machine learning method is used, which adapts itself to the vehicle and its seating locations.

In detail, FIG. 4 shows an exemplary method 400 for logging in 106 the user to the determined seating location in the vehicle. Once the sitting position of the user has been determined, the method 400 can log the user into the vehicle. In order to log in the user, the mobile terminal can provide 402 a confirmation message to the logging the user into the determined seating user in the vehicle. The confirmation message can location a log-in proposal and/or a proposed seating include location in the vehicle. The user can confirm 404 the confirmation message for logging the user into the determined seating location in the vehicle. The steps 402 and 404 are optional and can increase the security of the method 400, in that the user must confirm the log-in process. Alternatively, the user can log into the determined seating location in an automated manner without confirmation by the user. When the log-in of the user is carried out in an automated manner, the steps 402 and 404 are not carried out. The vehicle can log the user into the vehicle by of means a standardized authentication and authorization process. For example, the vehicle can log in the user by means of the OAuth 2.0 Device Authorization Grant Standard.

In step 406, the mobile terminal 202 can transmit 406 a message to register the parameters “user code” and/or “URI” to the vehicle. Upon registration of the parameters “user code” and/or “URI” by the mobile terminal, the mobile terminal can receive the user code and/or the URI from the vehicle in an automated manner. In step 408, the vehicle 204 can transmit a client identifier of the vehicle to backend the server 206. Due to the transmission of the client identifier from the vehicle 204 to the backend server 206, the vehicle 204 can request access to the backend server. In response to the transmission 408 of the client identifier, the backend server 206 can transmit 410 a device code, the user code, and the URI, in particular a URI for verification by the user, to the vehicle. The steps 408 and 410 can be carried out similarly to the steps (A) and (B) of the OAuth 2.0 Device Authorization Grant Standard. The OAuth 2.0 Device Authorization Grant Standard is published as RFC 8628. The sequence of the OAuth 2.0 Device Authorization Grant Standard is shown in FIG. 1 of the RFC 8628. In addition, the message can include the parameter “confirm the log-in request”, which initiates the process to log the user into the vehicle. In step 412, the user code and the URI can be transmitted from the vehicle 204 to the mobile terminal 202. The step 412 can be carried out similarly to the step (C) of the OAuth 2.0 Device Authorization Grant Standard. In contrast to the step (D) of the OAuth 2.0 Device Authorization Grant Standard, in step 412, the user code and the URI can be transmitted in an automated manner by means of the parameters “user code” and “URI” from the vehicle 204 to the mobile terminal 202. Preferably, the parameters are transmitted from the vehicle 204 to the mobile terminal 202 using the first wireless communication protocol. For example, the first wireless communication protocol is Bluetooth Low Energy. Alternatively, only the user code can be transmitted from the vehicle 204 to the mobile terminal 202 in step 412 and the URI can be transmitted from the backend server 206 to the mobile terminal. For example, the URI can be transmitted from the backend server to the mobile terminal via a mobile radio communication protocol. In this way, the security of the transmission of the user code and the URI can be increased.

In addition, in step 412, in contrast to step (D) of the OAuth 2.0 Device Authorization Grant Standard, a user with a web browser can be eliminated. An app can be run on the mobile terminal, which automates the user with a web browser. Likewise, a QR code scan for transmitting the user code and the URI can be eliminated. As described above, these data can be transmitted in an automated manner via the first wireless communication protocol and transmitted from the vehicle to the mobile terminal and, in particular, to the app of the mobile terminal, when the parameters “user code” and “URI” of the log-in service are registered.

In step 414, the vehicle 204 can transmit the device code from the backend server 206 at cyclic intervals and can transmit the client identifier to the backend server in order to query whether the user has confirmed the log-in to the vehicle. The step 414 can be carried out similarly to step (E) of the OAuth 2.0 Device Authorization Grant Standard.

In addition, the mobile terminal can provide 416 a confirmation message for confirming the log-in request to the user of the mobile terminal and receive 417 a response message to the confirmation message from the user of the mobile terminal. As described above, that the confirmation message include the seating location of the user determined in step 104. Upon responding to the confirmation request, the user can confirm the log-in of the user and the seating location of the user in the vehicle.

The mobile terminal can respond 418 in an automated manner to the log-in request received in step 412. The step 418 can be carried out similarly to step (D) of the OAuth 2.0 Device Authorization Grant Standard. In contrast to (D) step of the OAuth 2.0 Device Authorization Grant-Standard, confirmation by the user is optional. The mobile terminal can authorize the log-in request in an automated manner. In addition, the mobile terminal can confirm the seating location in an automated manner. Therefore, the user can be logged into the seating location in the vehicle in a fully automated manner.

In step 420, the backend server 206 can validate the device code of the vehicle and transmit 420 this with an access token to the vehicle if the mobile terminal or the user of the mobile terminal has confirmed the access. If the mobile terminal or the user of the mobile terminal has not confirmed the access, the backend server can transmit an error message to the vehicle and/or transmit a message to the vehicle to continue the cyclic query 414. The step 420 can be carried out similarly to step (F) of the OAuth 2.0 Device Authorization Grant Standard.

Advantageously, the method 100 can carry out an automatic log-in to the vehicle. In addition, the method 100 can provide an automatic log-in proposal for a seating location in a vehicle to a mobile terminal without the need for the log-in process to be manually initiated. The user of the vehicle can be automatically logged into the vehicle or only needs to carry out one single user interaction in order to log into the seating location in the vehicle. Log-in information of the user does not need to be stored in the vehicle. It is also no longer necessary to scan a QR code in order to log the user into the vehicle. The user can also efficiently log into seating locations in the vehicle that do not have a display. In addition, due to the method, multiple users of the vehicle can log into their respective seating locations in parallel without the need for a display at each seating location.

### LIST OF REFERENCE CHARACTERS

100 method
102 identify a mobile terminal
104 determine a seating location
106 log in a user
200 method
202 mobile terminal
204 vehicle
206 backend server
208 scan a log-in service
210 offer a log-in service
212 identify the log-in service
214 connect to vehicle
216 offer parameters
218 generate and transmit public vehicle identifier
220 retrieve the public vehicle identifier
222 check the public vehicle identifier
224 establish a secure communication link
226 expand a secure communication link
228 exchange security data
230 exchange security data
232 establish a secure communication link
300 method
302 request UWB token
304 generate UWB token
306 transmit UWB token
308 transmit UWB token
310 determine the position of the mobile terminal
312 generate a proposal for a sitting position
314 transmit the proposal to the mobile terminal
315 user
316 provide the proposed sitting position
318 manually change the sitting position
320 transmit the changed sitting position
400 method
402 provide a log-in proposal
404 confirm the log-in proposal
406 register parameters
408 transmit client identifier
410 transmit device code, user code, and URI
412 transmit user code and URI
414 transmit device code and client identifier
416 provide confirmation message
417 receive response message
418 answer log-in request
420 transmit an access token

1.-10. (canceled)

11. A method for logging a user into a vehicle, the method including:
identifying a mobile terminal of the user, the mobile terminal of the user being identified using a first wireless communication protocol;
determining a seating location of the user in the vehicle, the seating location of the user in the vehicle being determined using a second wireless communication protocol; and
logging the user into the determined seating location in the vehicle using the vehicle.

12. The method as claimed in claim 11, wherein logging the user into the determined seating location in the vehicle includes:
providing a message to log the user into the determined seating location in the vehicle from the vehicle to the mobile terminal of the user;
receiving a confirmation message from the mobile terminal to the vehicle; and
once the confirmation message has been received, logging the user into the determined seating location in the vehicle by means of the vehicle.

13. The method as claimed in claim 12, wherein the second wireless communication protocol is ultra-wideband.

14. The method as claimed in claim 12, one of the preceding claims, the method further comprising:
configuring a determined seating location in the vehicle according to a user-specific profile once the user has been logged into the determined seating location.

15. The method as claimed in claim 14, wherein the second wireless communication protocol is ultra-wideband.

16. The method as claimed in claim 11, wherein logging the user into the determined seating location in the vehicle includes:
receiving a message to log the user into the determined seating location in the vehicle from the vehicle to the mobile terminal of the user;
receiving a confirmation message to log the user into the determined seating location from the user by the mobile terminal;
transmitting the received confirmation message from the mobile terminal to the vehicle.

17. The method as claimed in claim 16, wherein the message to log the user into the determined seating location includes one single button on a graphical user interface of the mobile terminal, with which the user can log into the determined seating location in the vehicle.

18. The method as claimed in claim 17, wherein the confirmation message includes one single interaction of the user with the one single button on the graphical user interface of the mobile terminal.

19. The method as claimed in claim 11, one of the preceding claims, the method also including:
configuring a determined seating location in the vehicle according to a user-specific profile once the user has been logged into the determined seating location.

20. The method as claimed in claim 11, wherein the first wireless communication protocol is Bluetooth Low Energy.

21. The method as claimed in claim 20, wherein the second wireless communication protocol is ultra-wideband.

22. The method as claimed in claim 11, wherein the second wireless communication protocol is ultra-wideband.

23. The method as claimed in claim 11, wherein logging the user into the determined seating location in the vehicle includes an authentication and authorization of the user carried out using a standardized authentication or authorization protocol.

24. The method as claimed in claim 11, wherein logging the user into the determined seating location in the vehicle includes an authentication on the basis of OpenID Connect.

25. The method as claimed in claim 11, wherein logging the user into the determined seating location in the vehicle includes an authorization of the user using an OAuth 2.0 protocol.

26. The method as claimed in claim 25, wherein a user code or a verification URI of the OAuth 2.0 protocol is transmitted from the vehicle to the mobile terminal of the user via a Bluetooth Low Energy protocol.

27. A computer-readable medium for logging a user into a vehicle, wherein the computer-readable medium includes instructions which, when run on a computing device, carry out the method as claimed in claim 11.

28. A system for logging a user into a vehicle, wherein the system is designed to carry out the method as claimed claim 11.

29. A vehicle including the system for logging a user into a vehicle as claimed in claim 28.
